(19) United States
(12) Patent Application Publication
(10) Pub. No.: US 2026/0249366 A1
(43) Pub. Date: Aug. 27, 2026

(54) TOOL COMPONENT AND METHOD FOR PRODUCING A TOOL COMPONENT

(71) Applicant: TIGRA GMBH, Oberndorf (DE)

(72) Inventors: Thomas LIPPUS, Donauwörth (DE); Bernd MOTZER, Donauwörth (DE)

(73) Assignee: TIGRA GMBH, Oberndorf (DE)

(21) Appl. No.: 19/489,689

(22) PCT Filed: Aug. 7, 2024
(86) PCT No.: PCT/EP2024/025243

§ 371 Date: Dec. 3, 2025

(30) Foreign Application Priority Data
Aug. 7, 2023 (DE) 10 2023 003 258.1

(51) Int. Cl. B23C 5/00; B22F 10/18; B22F 10/64; B33Y 10/00; B33Y 40/20; B33Y 80/00

(52) U.S. Cl. CPC B23C 5/006; B22F 10/18; B22F 10/64; B33Y 10/00; B33Y 40/20; B33Y 80/00; B22F 2998/10; B23C 2250/12

(57) ABSTRACT

A tool component of a machine tool comprises a functional body having at least one functional surface and a support body which supports the functional body wherein the functional body has at least one surface for fixing or guiding the tool component within the machine tool, wherein the functional body is formed at least partially from a solid material. The tool component is characterized in that the structure of the support body adjoins the structure of the functional body, the functional body at least partially has a carrying structure having cavities, and the carrying structure is formed at least partially from a hard material, a hard metal or a hard alloy on a chromium-cobalt basis.

The present invention relates to a tool component of a machine tool, comprising a functional body having at least one functional surface and a support body which carries the functional body, wherein the functional body has at least one surface for fixing or guiding the tool component within the machine tool, wherein the functional body is formed at least partially from a solid material. The present invention further relates to a method for producing such a tool component.

DE 10 201 6 108 507 A1 discloses a cutting tool having a rake face and free faces which has an inner cavity which comprises one or more lattice structures. These lattice structures are intended to enable lightweight construction, as a result of which a cost-effective production is also to be provided.

DE 10 201 6 221 518 A1 discloses a tool holder for a cutting machine, which tool holder has a main body with a fixing region for fixing a tool holder in the cutting machine and a receiving region for receiving and fixing a machining tool. This base body is to be formed at least partially from a support structure having cavities. The cavities can be shaped as a honeycomb structure, as a spoke structure, as a tubular structure or in a variety of other ways.

EP 4 063 047 A1 also discloses such a tool holder for a cutting machine.

It is the object of the invention to provide a tool component with high wear resistance.

This object is achieved, as indicated in patent claim 1.

It is likewise the object of the invention to provide a method for producing a tool component.

This object is achieved, as indicated in patent claim 8.

Advantageous developments result from the respective dependent claims.

According to the invention, hard metals or hard alloys based on cobalt-chromium are provided for use in the support body because they are distinguished on the one hand by their high hardness, but also by their toughness and wear resistance. Hard metals are metal matrix composite materials in which hard materials that are present as small particles are held together by a matrix of metal. Tungsten carbide (WC) is usually used as the hard material, but it can also be titanium carbide (TiC), titanium nitride (TiN), niobium carbide, tantalum carbide or vanadium carbide.

According to the invention, hard metals and hard materials can be used for the production of tools or tool parts for cutting, punching, shaping, pressing, lowering and drawing tools because of their high wear resistance. For example, they can also be used as parts of tools for the manufacture of products of metal and ceramic powders, for stamped parts in automotive and electrical engineering and for the drawing of metal containers and bricks. Due to their comparatively low wear, components made of hard metal or hard materials or the above-mentioned alloys are also gentle on the machine, since hardly any abrasion occurs which passes into the production machine.

According to the invention, the tool part comprises a functional body, which can be a solid block or a round or angular rod, a ring or a shaped blank; in individual exemplary embodiments, bores or other recesses are also present in the functional body. A tool part within the meaning of the present invention is also to be understood as a machine part.

The functional body forms the working part of a tool or a tool component, which only fulfills a functional or work task on its surface, while a component of the tool or of the tool component adjoins the functional body or a core of the tool or of the tool component which has only a supporting and shape-preserving function and is therefore referred to below as a supporting body.

According to the invention, it is provided that instead of the compact structure of the core known from the prior art, the support body is replaced by a honeycomb, cell-shaped grid-like structure made of the same or another material which continues to take over the supporting function of the hitherto solid core.

The tool component according to the invention has an operating part or a functional part made of hard metal or a hard alloy. At least one side surface of the tool or tool component consists of solid material, which does not exclude that the support body also has outer surfaces or parts made of a solid material.

The core of the support body consists of the same or a different material as the functional body and is distinguished, for example, by a honeycomb or grid-shaped structure.

The support body or the entire component is produced by means of additive manufacturing, in particular by means of a 3D Print. A production method known from 3D printing, in particular, fused deposition modeling (FDM) or fused filament fabrication (FFF) can be taken into account; using these methods, a workpiece can be built up in layers from molten metal.

Due to the partially hollow structure of the support body, a weight saving of the component to the solid material of at least 15% can be achieved; resources are spared by the reduction of the component weight.

Advantageous developments result from the dependent claims and the description, in particular in conjunction with the drawings.

The tool component according to the invention preferably comprises an annular, rectangular, cylindrical or sliding block or functional body formed as a shaped blank. According to an advantageous embodiment, it is provided according to the invention that at least the support body is produced at least partially by an additive manufacturing method and that the support body, insofar as it is produced by the additive method, has a support structure produced by the additive manufacturing method.

If the support structure of the support body has a textured structure, a honeycomb structure, a meandering structure or a structure comprising gyroids or a structure having at least substantially periodic or statistically scattered structural support elements, a weight proportion of at least 15% relative to a solid body can be saved, as a result of which valuable raw material is saved. Despite the weight saving, the full functionality of the tool component is ensured.

Advantageously, it can be provided that the tool component has a support body with a closed-pore structure or with a structure comprising at least one channel.

In a further embodiment of the invention, it is provided that the at least one channel serves as a temperature-control channel, as a result the temperature range in which the tool operates in a wide range can be set and wear can be reduced. Furthermore, an open-pore support structure can additionally be used for the uniform or targeted distribution of a cooling, heating or lubricating medium in order to control the temperature of the tool or the machine part, or also to lubricate it.

In a method for producing a tool component or a tool or a machine component, the functional body is produced by a casting method or by an additive manufacturing method, while the support body, building on the functional body or adjoining the functional body, is produced in any case by an additive method.

Advantageously, it is provided that the tool component is sintered during or after the implementation of the production method.

It is also evident that the tool component produced according to the invention has an effective and adaptable damping behavior and high stability in the case of simple producibility.

The above-described tool component serves, for example, for use in a forming machine. As such, for example, a bending machine or a deep-drawing machine can be referred to.

The tool component comprises, for example, a shaft or cylinder-shaped or ring-shaped functional or base body, through which the tool component can be fixed within a tool or can be moved along a contour, for example along a circular or an oval contour In such a case, the functional body has the shape of a piston which can be moved within a hollow cylinder. In another exemplary embodiment, a fixing region serves for fixing the functional body of the tool component in a cutting machine The fixing region is thus configured to be received by the cutting machine or to be fixed in the cutting machine, for example to be clamped. The functional body is characterized in that it has at least one functional surface by means of which it acts on the part to be machined in the machine tool, for example a metal surface to be formed. In addition, the functional body has, for example, at least one guide surface over which the functional body is guided within the tool. The functional body likewise has at least one surface via which it is connected to the support body. In one embodiment, the functional body and/or the support body are ring-shaped or cylindrical. According to the invention, however, any contours of the functional body can be realized, for example also cuboid structures.

According to the invention, it is provided that the support body is formed at least partially from a support structure which has cavities. In this case, the support body is constructed, for example, from a support structure which is formed in such a way that it has cavities and encloses it; the support body is, for example, porous. In principle, a cavity is understood to mean any cavity which is defined by the support structure and is thus surrounded and closed by the latter.

Due to the fact that the support body is formed at least partially from a support structure having cavities, wherein the cavities are also filled with a fluid or a solid material, for example a granular material, an effective damping behavior can be formed. This applies in particular to a body formed from solid material, as is known from prior art. In detail, the embodiment of a support structure with cavities leads to the weight or the mass of the material which fills the cavities of the support body exerting a certain inertia on the entire tool component. This inertia leads to the damping of the tool component.

A further advantage of such a supporting body is that an effective adaptability of the damping properties is provided. This is because damping behavior can be adapted in a simple manner to the desired field of application by the filling quantity, the filled pulverulent material or by the number and size of the cavities, which is to say the volume ratio of cavities to supporting structure.

As a result of the structure described above, such a support body offers substantially comparable stability compared to a support body of a tool component formed from a solid material.

The support body is preferably produced at least partially by an additive method. For example, the support body can be formed completely by an additive method. By means of an additive or a generative method, such as by a selective laser melting method, binder jetting (free-jet binder application) or FDM pressure, a tool component having a comparatively complex structure can be produced quickly and in a defined manner. In particular, the structure of the support body with a support structure and cavities can be simple.

as a result of conventional manufacturing technology, this was not possible or at least not trivial.

A cavity with a very large surface is created by the textured or honeycomb-shaped or truss-like or other connecting struts or connecting tubes or adjacent tubes, which creates a good heat transfer from the supporting body to a cooling fluid flowing through the cavity, so that the supporting body is well suited for controlling the temperature of the functional body. Particularly preferably, a plurality of temperature control channels is arranged This can be advantageous for the functionality of the tool component, since it is often desired or necessary to cool or heat the region at which forming or machining or other material processing takes place, for example with a fluid which is preferably a lubricant at the same time as a heat exchanger. For example, the temperature control channel or the temperature control channels running through the tool component can have one or more inlets through which the temperature control channels can be connected to the machine tool, for example the forming machine or the cutting machine.

It may further be preferred that the cavities are formed in the support body in the form of a honeycomb structure. This is intended in particular to mean that, in the case of a cross-section through the cavities, the support structure delimiting the cavities has a hexagonal honeycomb structure, for example comparable to honeycombs. In particular in this embodiment, a high stability can also be made possible in the case of a support structure which is formed from comparatively little material. This embodiment may further enable, for example, in an additive method such as laser sintering, that a lot of manufacturing time can be saved, which can make the manufacturing method particularly economical. Furthermore, a honeycomb structure can be advantageous since the regions or parts of the support structure are optimally cross-linked in the interior, which can lead to a high stability.

In addition to a honeycomb structure which can preferably be provided, however, further structures or texturing can be preferred in which the cavities have a tubular alignment or a tubular profile and are formed in parallel. Examples are approximately cylindrical structures or triangular structures in a cross-section through the cavities.

The method for producing the tool component enables simple and economical producibility, as is described in detail below.

For example, it may be preferred that the functional body is also formed at least partially and the support body is formed completely by an additive method, wherein the additive method leads to a very high strength and stability using a hard metal or an alloy of hard metals or a cobalt-chromium-based hard alloy.

An additive or a generative method can be understood to mean, in particular, a process in which a component is produced layer by layer on the basis of digital 3D construction data by depositing or building up material. Examples of such processes include, for example, 3D printing, under which FDM pressure or the binder jetting method is often also understood. Additive manufacturing method differs significantly from conventional, ablating manufacturing methods. Instead of milling a workpiece from a solid block, for example, as is known in the case of removing methods, the components are built up in an additive manufacturing process, in particular a layer for layer of materials or raw materials, which are present as starting material, in particular fine powder or filament.

A laser, such as a CO₂ laser, an Nd: YAG laser or a fiber laser, or also an electron beam source, is used for processing such as for example for melting the raw material in particular in powder form.

Using an additive method, it is particularly advantageous that the base body as a whole can be produced in a simple production step. As a result, simple process sequences can be implemented, which can reduce the manufacturing effort. In addition, by means of an additive method without increasing the manufacturing effort, essentially any structure with cavities is made possible, which can further improve adaptability in terms of stability and coolant use.

By means of an additive method, the support structure in the raw material can be formed in a simple manner by melting, while the further raw material can remain in the cavities. This allows a simple method, since the remaining raw material remains straight in the case of conventional additive methods, since this has to be removed in a further method step. If no raw material remains in the cavities through the use of an FDM method, this can be achieved by binder jetting. Binder jetting, also referred to as free-jet binder application, is an additive manufacturing process in which powdered starting material is bonded at selected locations with a liquid binder in order to produce workpieces.

As a result, the invention provides a component, in particular a tool part or a machine part, which consists at least partially of a hard material, a hard metal or a cobalt-chromium-based hard alloy. A component according to the invention is suitable for replacing machine or tool parts (or tools) which have hitherto been manufactured from, for example, hardened tool steel for reasons of wear, by the above-mentioned hard materials, hard metals or cobalt-chromium-based hard alloys, wherein weight optimization is taken into account in consideration of the machine dynamics. According to the invention, cavities are preferably provided which compensate for the higher weight of the metals or metal compounds used according to the invention or even allow a lower weight than can be achieved with conventional metals.

In addition to reducing the wear on the functional surfaces, the advantages of the invention also include weight optimization with the aim of generating components that are equally heavy or lighter. Since, for example, hard metal has approximately twice the density of steel and, as a solid component, disadvantages in machine dynamics with respect to speed and increased vibrations and increased wear at other points and more energy consumption would bring about, better machine dynamics are achieved by the introduction of cavities according to the invention, in particular by honeycomb, grid-shaped or cell-shaped cavities, but also by other cavities provided according to the invention.

Laser sintering can be used both in parts made of hard metal and in the case of stellite-like alloys.

A manufacturing method, which is preferably used, is the FDM or FFF method, by means of which a body of a tool component is built up in layers with a hard material filament which contains a thermoplastic binder. Thereafter, a part of the plastic is removed again by means of solvent debinding for preparation for the sintering process, which allows only limited maximum wall thickness. In this case, the gyroid structure is advantageous since it is open-pored and therefore also permits debinding from the inside if small bores are attached for the penetration of the solvent.

According to the invention, the functional body assumes the primary function of guiding the component within the machine tool and ensures a uniform surface structure which is adapted to the conditions within the machine tool, such as the temperatures or the substances contacting or acting on the functional body from the outside.

Secondary functions such as the fastening, the force transmission, the bearing and guiding functions are used for the supporting body. In this case, the filling structure is designed such that it takes over the supporting function, while at the same time the weight is reduced compared to the structures known from the prior art. The filling structure takes over special functions such as force transmission or through channels introduced into it the function of fluid guidance, temperature control and/lubrication. The support body is at least partially integrated into the functional body. The support body preferably differs from the functional body only by the transition to the support structure.

The invention is described in more detail below on the basis of preferred exemplary embodiments.

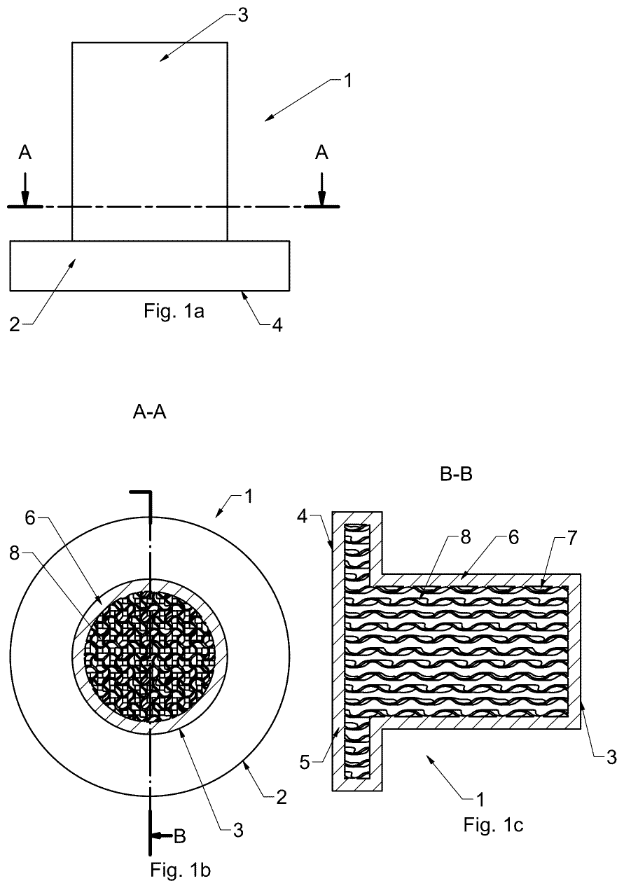

FIG. 1a shows a lateral plan view of a first tool component,

FIG. 1b shows a horizontal sectional view of the first tool component along a section line A-A from FIG. 1a,

FIG. 1c shows a vertical sectional view of the first tool component along a section line B-B from FIG. 1b,

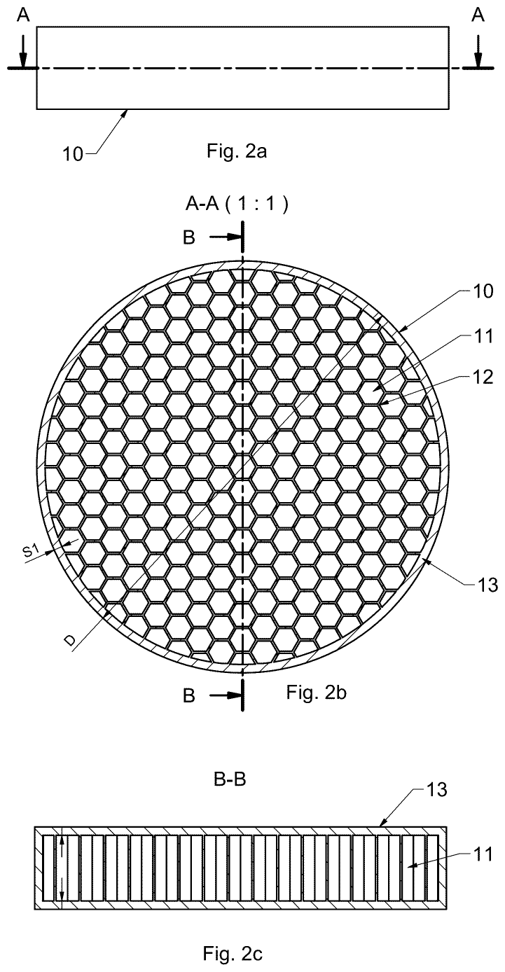

FIG. 2a shows a lateral plan view of a support body of a second tool component,

FIG. 2b shows a horizontal sectional view of the support body along one section A-A from FIG. 2a,

FIG. 2 c shows a vertical sectional view of the support body along one Section B-B from FIG. 2b,

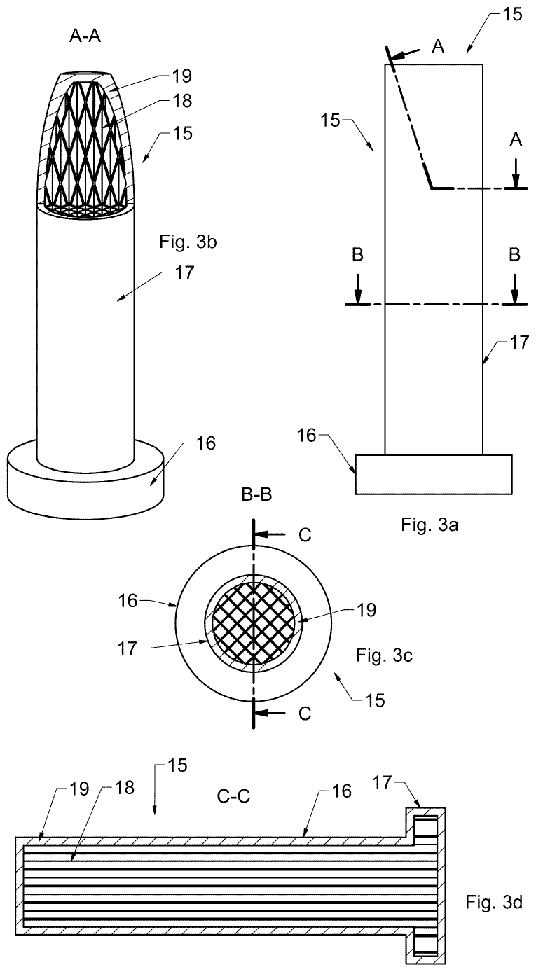

FIG. 3a shows a lateral plan view of a third tool component,

FIG. 3b shows a side view of the third tool component, partially cut along a section line A-A from FIG. 3a,

FIG. 3c shows a horizontal sectional view of the third tool component along a section line B-B from FIG. 3a,

FIG. 3d shows a vertical sectional view of the third tool component along a section line C-C from FIG. 3c,

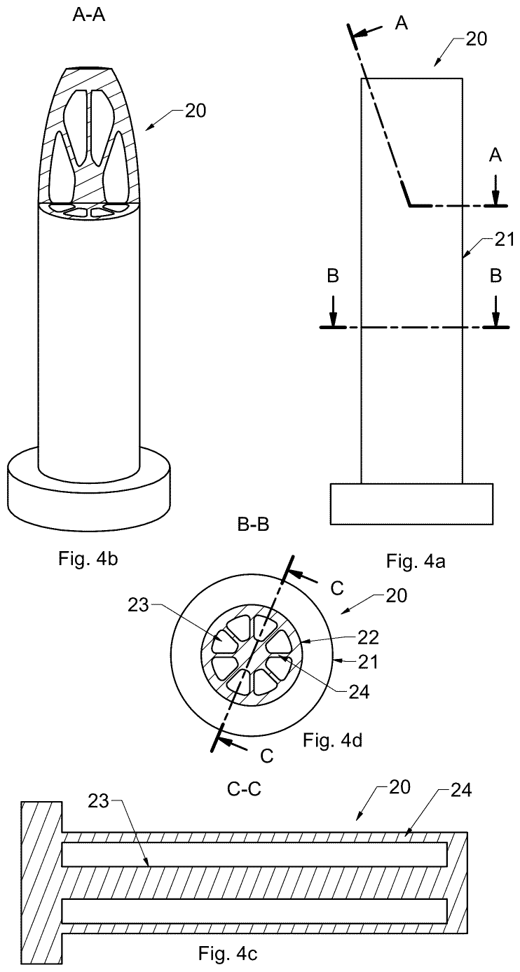

FIG. 4a shows a lateral plan view of a fourth tool component,

FIG. 4b shows a side view of the third tool component, partially cut along a section line A-A from FIG. 4a,

FIG. 4c shows a horizontal sectional view of the third tool component along a section line B-B from FIG. 4a,

FIG. 4d shows a vertical sectional view of the third tool component along a section line C-C from FIG. 4c,

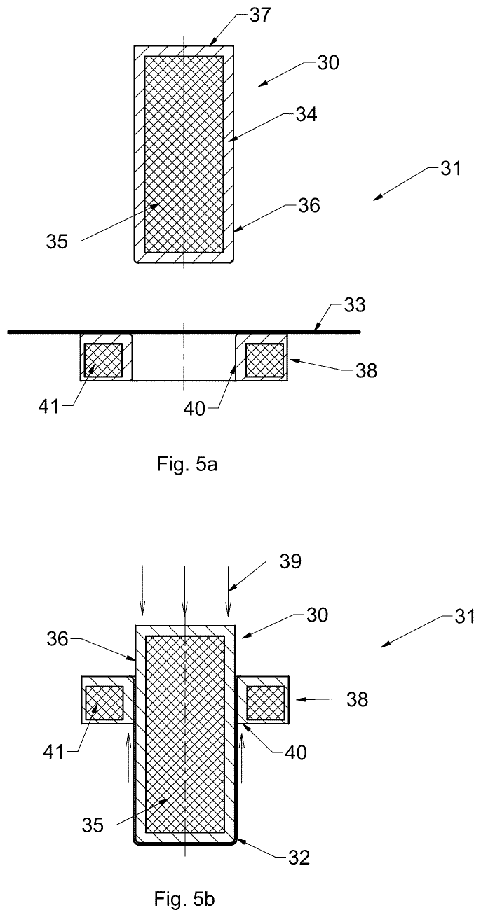

FIG. 5a shows a vertical sectional view through a schematically illustrated tool component with a punch, which can be guided through a die, for forming a cylindrical hollow body together with a sheet metal blank to be machined by the tool prior to the deformation, and

FIG. 5b shows a vertical sectional view of the tool component according to FIG. 5a after deformation of the sheet metal blank to the cylindrical hollow body, wherein the punch is passed through the die.

A tool component 1 (FIGS. 1a-1c) comprises a cylindrical functional body 2 and a likewise cylindrical supporting body 3, which is shown above the functional body 2 and is fixedly connected to the functional body 2. The strength and stability of the functional body 2 are ensured by the functional layer 5 forming a functional surface 4. The functional layer 5 is connected on both sides to an outer wall 6 of the support body 3 and merges into the latter.

The functional body 2 and the supporting body 3 are preferably formed both in their walls 5 and 6 (functional layer 5 and outer wall 6) in each case by the same hard material, the same hard metal or the same hard alloy based on cobalt-chromium. In another exemplary embodiment, the functional body 2 and the supporting body 3 have the same diameter. Instead of a circular cross-section, the functional body 2 and the support body 3 can have any other cross-sections, for example elliptical cross-sections.

In its interior, the functional body 2 and the supporting body 3 consist of the same supporting structure 7, which comprises channels or cavities 8 and supporting walls 9 arranged between them. The support walls consist of a triple periodic minimum structure, which also counts the known shape of a gyroid. This open-pore 3-D structure contains the advantages of simple printability with minimal material use and, in this case, high strength in all axial directions. In addition, open porosity facilitates the further production process by reducing massive material thicknesses. Overall, the inner region of the functional body 2 merges seamlessly into the inner region of the support body 3 and is produced in the same additive manufacturing method.

A further, likewise cylindrical supporting body 10 (FIGS. 2a-2c) has a honeycomb structure 11 with honeycombs 12 in its interior. The honeycombs 12 have walls extending in a vertical direction. A functional body (not shown here), on which the support body L is placed, is likewise constructed, for example, as the support body 0, or it consists of solid material.

In a further exemplary embodiment, a tool component 15 (FIGS. 3a-3d) having a functional body 16 and a supporting body 17 is configured in its outer structure as the tool component 1. in its interior the functional body 16 and the supporting body 17 each have a square structure 18. The functional body 16 and the supporting body 17 have a common wall 19.

In another exemplary embodiment, a tool component 20 (FIGS. 4a-4d) having a functional body 21 and a support body 22 is configured in its outer structure as the tool components 1 and 15. In its interior, the support body 22 has a spoke structure 23; on the other hand, the functional body 22 is formed from a solid material.

In a further exemplary embodiment (FIG. 5a, 5b), a punch 30 of a tool or tool component 31 for forming a hollow cylinder 32 comprises a sheet metal blank 33, i.e. a circular metal sheet, for example made of aluminum, a functional body 34, which surrounds a supporting body 35 at least on the side facing the sheet metal blank 33, preferably also on its lateral surface 36, preferably also on its upper side 37. However, in another embodiment of this exemplary embodiment, connections for the supply line can be provided on the upper side 37 and discharge of fluids serving, for example, for cooling, which are passed through the structure of the support body 35.

By pressing the punch 30 through a die 38 in the direction of an arrow 39 together with the sheet metal blank 33, the punch 30 deforms the sheet metal blank 33 to the hollow cylinder 32, which can serve to produce a closed cylindrical container.

The die 38 also comprises a functional body 40 and, in its interior, a supporting body 41. This can also be supplied with a fluid in a configuration (not shown here) in order, for example, to cool the support body 1.

Alternatively, the support body and/or the functional body have a plurality of different structures, for example columns, which extend in accordance with the longitudinal axis of the cylindrical shape of the support body and/or of the functional body and which form the support structure.

1. Tool component of a machine tool, comprising a functional body with at least one functional surface and a supporting body which carries the functional body, wherein the functional body has at least one surface for fixing or for guiding the tool component within the machine tool, wherein the functional body is formed at least partially from a solid material, wherein the structure of the supporting body adjoins the structure of the functional body, wherein the functional body at least partially has a supporting structure having cavities, and the supporting structure is formed at least partially by a hard material, a hard metal or a cobalt-chromium-based hard alloy.

2. Tool component according to claim 1, wherein the functional body is annular, rectangular, cylindrical, sliding block or shaped blank.

3. Tool component according to claim 1, wherein at least the supporting body is produced at least partially by an additive manufacturing method, and wherein the supporting body, insofar as it is produced by the additive method, has a supporting structure produced by the additive manufacturing method.

4. Tool component according to claim 3, wherein the support structure has a textured structure, a honeycomb-shaped structure, a spoke structure, a meandering structure or a structure comprising gyroids, or a structure having at least substantially periodic or statistically scattered structural support elements.

5. Tool component according to claim 1, wherein the supporting body has a closed-pore structure or a structure comprising at least one channel.

6. Tool component according to claim 5, wherein the at least one channel serves as a cooling channel.

7. Tool component according to claim 3, wherein the supporting structure has cavities with a volume fraction of at least 15 % of the total volume of the supporting body.

8. Method for producing a tool component according to claim 1, wherein the functional body is produced by a casting method or by an additive manufacturing method, and wherein the supporting body is produced on the functional body by an additive method.

9. Method according to claim 8, wherein the tool component is sintered during or after the production process is carried out.
